(19) United States
(12) Patent Application Publication
(10) Pub. No.: US 2011/0314116 A1
(43) Pub. Date: Dec. 22, 2011

(54) Method and System For Electronic Content Delivery Via Affilliates and Detecting Click Fraud

(75) Inventors: Greg Bayer, Brooklyn, NY (US); Andy Schon, New York, NY (US)

(73) Assignee: ADKNOWLEDGE, INC., Kansas City, MO (US)

(21) Appl. No.: 13/163,848

(22) Filed: Jun. 20, 2011

Related U.S. Application Data
(60) Provisional application No. 61/356,131, filed on Jun. 18, 2010.
(60) Provisional application No. 61/356,199, filed on Jun. 18, 2010.

(51) Int. Cl. G06F 15/16

(52) U.S. Cl. 709/206

(57) ABSTRACT

Systems and methods utilize affiliates in delivering content via electronic communications, over a communications network, transmitted from these affiliates to computers of intended recipients, over a the communications network. The content is rendered to the computer of the intended recipient dynamically and automatically when the intended recipient opens the electronic communication. The systems and methods also evaluate possible fraud from clicks received from these affiliate-transmitted electronic communications.

### CROSS REFERENCES TO RELATED APPLICATIONS

This application is related to and claims priority from commonly owned 1) U.S. Provisional Patent Application Ser. No. 61/356,131, entitled: Method and System for Electronic Content Delivery Via Affilliates, filed on Jun. 18, 2010; and, 2) U.S. Provisional Patent Application Ser. No. 61/356,199, entitled: Method and System for Electronic Content Delivery Via Affiliates and for Avoiding Click Fraud, filed on Jun. 18, 2010, the disclosures of both of these Provisional Patent Applications incorporated by reference herein.

### TECHNICAL FIELD

The present disclosed subject matter relates to content delivery over networks and components associated therewith.

### BACKGROUND

Electronic communications have dramatically changed the ways in which people communicate. Electronic mail, commonly referred to as e-mail, is a widely used form of electronic communication. E-mail is the exchange of computer-stored messages by telecommunication, over a network, such as the Internet. E-mail accounts for the largest percentage of total traffic on the Internet. E-mail usage continues to increase exponentially in the next few years as increasing numbers of people have access to computers, and therefore, the World Wide Web (WWW).

E-mail communications are desirable, as they are current, usually in real time, and are non-intrusive. Conversely, a telephone call is intrusive, as it must be attended to at the moment it is received, and may interfere with the recipient's activities. The e-mail recipient may open the e-mail when desired, and may delete the e-mail without reading it.

### SUMMARY OF THE DISCLOSED SUBJECT MATTER

This document references terms that are used consistently or interchangeably herein. These terms, including variations thereof, are as follows.

The term “click”, “clicks”, “click on”, “clicks on” involves the activation of a computer pointing apparatus, such as a device commonly known as a mouse, on a location on a computer screen display, for example, an activatable link, that causes an action of the various software and or hardware supporting the computer screen display.

A banner is a graphic that appears on the monitor of a user, typically over a web page being viewed. A banner may appear on the web page in forms such as inserts, pop ups, pop-behinds, roll ups, scroll ups, and the like.

A “web site” is a related collection of World Wide Web (WWW) files that includes a beginning file or “web page” called a home page, and typically, additional files or “web pages.” The term “web site” is used collectively to include “web site” and “web page(s).”

A uniform resource locator (URL) is the unique address for a file, such as a web site or a web page, which is accessible on the Internet.

A server is typically a remote computer or remote computer system, or computer program therein, that is accessible over a communications medium, such as the Internet, which provides services to other computer programs (and their users), utilizing the same or other computers.

A “creative” is electronic data representative of, for example, an advertising campaign, or other informational campaign or information, that appears as an image in graphics and text on the monitor of a user or intended recipient. The content for the creative may be static, as it is fixed in time. The creative typically includes one or more “hot spots” or positions in the creative, both in electronic data and the image that support underlying links, that are dynamic, as they are placed into the creative, at the time the creative is activated, which may be upon the opening of an electronic communication, or e-mail with the creative. The underlying links may also be “static”, in that they are placed into the creative at a predetermined time, such as when the creative is created, and fixed into the hot spots at that time. The hot spots include activatable graphics and/or text portions that overlie the links. When these activatable portions are activated or “clicked” on by a mouse or other pointing device, the corresponding underlying link is activated, causing the user's or intended recipients browsing application or browser to be directed to the target web site corresponding to the activated link.

Pay Per Click (PPC), also known as price per click and cost per click, as used herein, is the amount of money that an advertiser, web site promoter, or other party who owns or is associated with a web site, will pay to a system administrator for providing their advertisement, listing, link or the like to a user, and the user clicks their mouse or pointing device on the advertisement, listing, link or the like, such that the user's browser is directed to the targeted web site associated with the advertiser, web site promoter, or other party who owns or is associated with the targeted web site.

A “client” is an application that runs on a computer, workstation or the like and relies on a server to perform some operations, such as sending and receiving e-mail.

“n” and “nth” in the description below and the drawing figures represents the last member of a series or sequence of servers, databases, caches, components, listings, links, data files, etc.

“Click through” or “click throughs” are industry standard terms for a user clicking on a link in an electronic object, such as an e-mail, banner, listing on a web site, for example, a web site of a search engine, or the like, and ultimately having their browser directed to the targeted data object, typically a web site, associated with the link.

The present disclosed subject matter is directed to systems and methods which utilize affiliates in delivering content via electronic communications, over a communications network. The electronic communications are transmitted from these affiliates (computers, servers and/or computer devices associated with these affiliates, linked to the communications network) to computers of intended recipients, over a the communications network. The content is rendered to the computer of the intended recipient dynamically and automatically when the intended recipient opens the electronic communication. The systems and methods also evaluate possible fraud from clicks received from these affiliate-transmitted electronic communications.

The present disclosed subject matter improves on the contemporary art by creating a method and system to deliver more relevant content in communications to each user. For example, the present disclosed subject matter provides advertising and/or informational electronic communications, such as in the form of electronic mail (e-mail), which tends to be tailored to each user, based on behaviors (e.g., clicking or not clicking) and statistical correlations and other analytical data corresponding to or associated with the user (e.g., recipient of the electronic communication). Moreover, the e-mail, is provided by a provider, who also provides the content, but does not send the e-mail to the user. Rather, the sender of the e-mail may be third party sender, for example, an affiliate, and the e-mail is electronically linked to the content provider (as well as the affiliate), with the content provider providing the content to the e-mail dynamically, for example, once the e-mail is opened. Alternately, the content of the e-mail can be provided with static or fixed content.

An embodiment of the disclosed subject matter is directed to a method for providing content into electronic communications over a communications network. The method includes a computer system receiving a request for a body, for example, a creative, for an electronic communication over the communications network, the body for the electronic communication selected by an affiliate user accessing the computer system to select the body; the computer system sending data corresponding to the selected body to a computer device associated with the affiliate user, over the communications network, the computer device linked to the communications network; the computer system receiving the data corresponding to the selected body from an electronic communication opened on a recipient computer linked to the communications network, the data additionally including at least one content request, the opening of the electronic communication automatically transmitting the data to the computer system; and, the computer system responding to the received data by automatically providing: 1) data for an image (e.g., image data) for the body of the opened electronic communication for display on the recipient computer, to the recipient computer, and, 2) content for at least one portion of the body of the opened electronic communication. The automatic providing includes the computer system sending: 1) the data for an image for the body of the opened electronic communication for display on the recipient computer, to the recipient computer, and, 2) the content for at least one portion of the body of the opened electronic communication, to the recipient computer, and, the content is associated with a target web site. The electronic communication may be, for example, electronic mail (e-mail).

Another embodiment is directed to a computer-implemented method for providing content into electronic communications (for example, e-mails, banners and the like) over a communications network. The method (process) includes, a computer system, linked to the communications network, the computer system receiving a request for a body for an electronic communication over the communications network from an affiliate user of the computer system, the body for the electronic communication selected by the affiliate user accessing the computer system to select the body; the computer system sending data corresponding to the selected body to a computer device associated with the affiliate user, over the communications network, the computer device linked to the communications network, the data corresponding to the selected body for placement into electronic communications of the affiliate user, the electronic communications for transmission to computers of intended recipients over the communications network, the computers of the intended recipients linked to the communications network, the intended recipients as designated by the affiliate user; the computer system receiving the data corresponding to the selected body from an electronic communication opened on a computer of an intended recipient, the data additionally including at least one content request, the opening of the electronic communication automatically transmitting the data of the at least one content request to the computer system; and, the computer system responding to the received data by automatically providing to the computer of the recipient, to the opened electronic communication: 1) data for an image for the body, and, 2) content for at least one portion of the body, the content corresponding to the at least one content request.

The image for the body includes, for example, a creative, and the at least one portion of the body includes a hot spot in the creative, the hot spot configured for being activated and for supporting at least one activatable link associated with the content, the hot spot, when activated, causing activation of the at least one activatable link, such that the browsing application, associated with the computer of the recipient, is directed to the target web site (for example, a web page, such as a home page of the target web site), also known as a target data object.

Another embodiment is directed to a system for providing content into electronic communications over a communications network. The system comprises a computer system in communication with at least one storage media. The computer system is linked to the communications network and configured for: receiving a request for a body for an electronic communication over the communications network from an affiliate user of the computer system, the body for the electronic communication selected by the affiliate user accessing the computer system to select the body; sending data corresponding to the selected body to a computer device associated with the affiliate user, over the communications network, the computer device linked to the communications network, the data corresponding to the selected body for placement into electronic communications of the affiliate user, the electronic communications for transmission to computers of intended recipients over the communications network, the computers of the intended recipients linked to the communications network, the intended recipients as designated by the affiliate user; receiving the data corresponding to the selected body from an electronic communication opened on a computer of an intended recipient, the data additionally including at least one content request, the opening of the electronic communication automatically transmitting the data of the at least one content request to the computer system; and, responding to the received data by automatically providing to the computer of the recipient, to the opened electronic communication: 1) data for an image for the body, and, 2) content for at least one portion of the body, the content corresponding to the at least one content request. The at least one storage media is for storing data, such as image data and text data for bodies, for example, creatives, for electronic communications. The system also includes an imaging server for converting text data into data for images for the bodies of opened electronic communications.

Another embodiment is directed to a computer-implemented method for detecting fraudulent clicks over a communications network. The method (process) comprises: receiving, by a computer system linked to the communications network, 1) clicks from electronic communications for a target data object, from an affiliate server mapped back to the computer system, and, 2) data for clicks resulting in conversions for the target data object associated with the electronic communications from the affiliate server; analyzing, by the computer system, the mapped back clicks and the data for the clicks resulting in conversions with respect to at least one threshold; and determining possible fraudulent clicks, by the computer system, if the mapped back clicks at least meet or exceed the at least one threshold. The method additionally comprises, matching, by the computer system, the mapped back clicks with the corresponding data for the clicks resulting in conversions, for the entity associated with the target data object, and maintaining, by the computer system, monetary accounts for entities associated with target data objects, the entities also associated with affiliates and their corresponding affiliate servers.

Additionally, if the at least one threshold is either met or exceeded, the computer system ceases to debit the account of the entity associated with the target data object by an amount for each mapped back click. The amount for each mapped back click includes a bid amount for a click made by the entity associated with the target data object. Also, if the at least one threshold is either met or exceeded, the computer system blocks the internet protocol (IP) address of the target data object.

The at least one threshold is based on at least one of, 1) a predetermined number of mapped back clicks for the target data object over a predetermined time, or 2) a predetermined number of mapped back clicks for the target data object as mapped back through the affiliate server. The target data object includes at least one of a web page or a web site.

Another embodiment is directed to a system for detecting fraudulent clicks over a communications network. The system includes at least one server for linking to a communications network comprising a storage medium for storing computer components, and a processor for executing the computer components. The computer components include a first component for receiving, 1) clicks from electronic communications for a target data object from an affiliate server, the clicks mapped back to the computer system from the affiliate server, and, 2) data for clicks resulting in conversions for the target data object associated with the electronic communications from the affiliate server; a second component for analyzing the mapped back clicks and the data for the clicks resulting in conversions with respect to at least one threshold; and, a third component for determining possible fraudulent clicks, if the mapped back clicks at least meet or exceed the at least one threshold. There is also a fourth component for at least one of, 1) ceasing to debit the account of the an entity associated with the target data object by an amount for each mapped back click, or 2) blocking the internet protocol (IP) address of the target data object; if the at least one threshold is either met or exceeded. The target data object includes at least one of a web page or a web site.

### BRIEF DESCRIPTION OF THE DRAWINGS

Attention is now directed to the drawings, where like reference numerals or characters indicate corresponding or like components. In the drawings:

FIG. 1A is a diagram of an exemplary system on which an embodiment of the disclosed subject matter is performed;

FIG. 1B is a diagram of a system used in the home server of the system of FIG. 1A;

FIG. 2 is a flow diagram of a process for generating an electronic communication in accordance with an embodiment of the disclosed subject matter;

FIG. 3 is a screen shot showing e-mail communications in the mailbox of a recipient;

FIG. 4 is a screen shot of an exemplary template in accordance with an embodiment of the disclosed subject matter;

FIG. 5 is a diagram of a creative in accordance with the disclosed subject matter;

FIG. 6 is a screen shot of the a creative in accordance with the disclosed subject matter;

FIG. 7 is a screen shot showing a web page accessed from a redirect uniform resource locator in accordance with the disclosed subject matter;

FIG. 8 is an account record of an affiliate account; and,

FIG. 9 is a flow diagram of a process for evaluating possible click fraud on the disclosed systems.

### DETAILED DESCRIPTION OF THE DRAWINGS

The present disclosed subject matter is related to systems and methods for providing content to third parties, for example, publishers or affiliates, for placement into electronic communications by the third party, publisher, or affiliate, for intended recipients of the third parties, publishers, or affiliates. The recipients are typically in a database or list of the publisher, which is, for example, a list which recipients have consented to, an opt-in list, or the like. The publisher or affiliate may not be related to the content provider and the publisher or affiliate is the sender of the electronic communication with the provided content. The electronic communications that include the provided content are such that portions of the content are time relevant, are generated dynamically, in that they are generated automatically, and typically in real time, when the electronic communication is activated, opened, or the like.

The content for the electronic communication, for example, data corresponding to a predetermined image with portions therein for receiving content generated when the electronic communication is opened, is delivered to the intended recipient by the third party or affiliate. The time relevant or dynamic content is delivered to and placed into designated locations of the image when the electronic communication, typically in the form of an electronic mail (e-mail), is opened, for example, in accordance with U.S. patent application Ser. No. 10/915,975, entitled: Method And System For Dynamically Generating Electronic Communications, filed Aug. 11, 2004 (U.S. Patent Application Publication No. US 2005/0038861 A1), the disclosure of which is incorporated by reference herein.

The content, formed, for example, of static and dynamic portions, as well as the e-mails and the data to fill the static content or image, resulting from the opened e-mail, are sent over digital, electronic, wire line or wireless communications networks, such as the Internet. The time relevant content for the e-mail is dynamic, as it may be generated in real-time, and assembled automatically when the electronic communication, for example, the electronic mail, is opened by the recipient (user). Should the electronic communication be closed and reopened at a subsequent time, it may have dynamic content different from the dynamic content when originally opened, as its content is assembled automatically at the time of reopening, for example, as disclosed in U.S. patent application Ser. No. 10/915,975 (U.S. Patent Application Publication No. 2005/0038861 A1).

Throughout this document, numerous textual and graphical references are made to trademarks. These trademarks are the property of their respective owners, and are referenced only for explanation purposes herein.

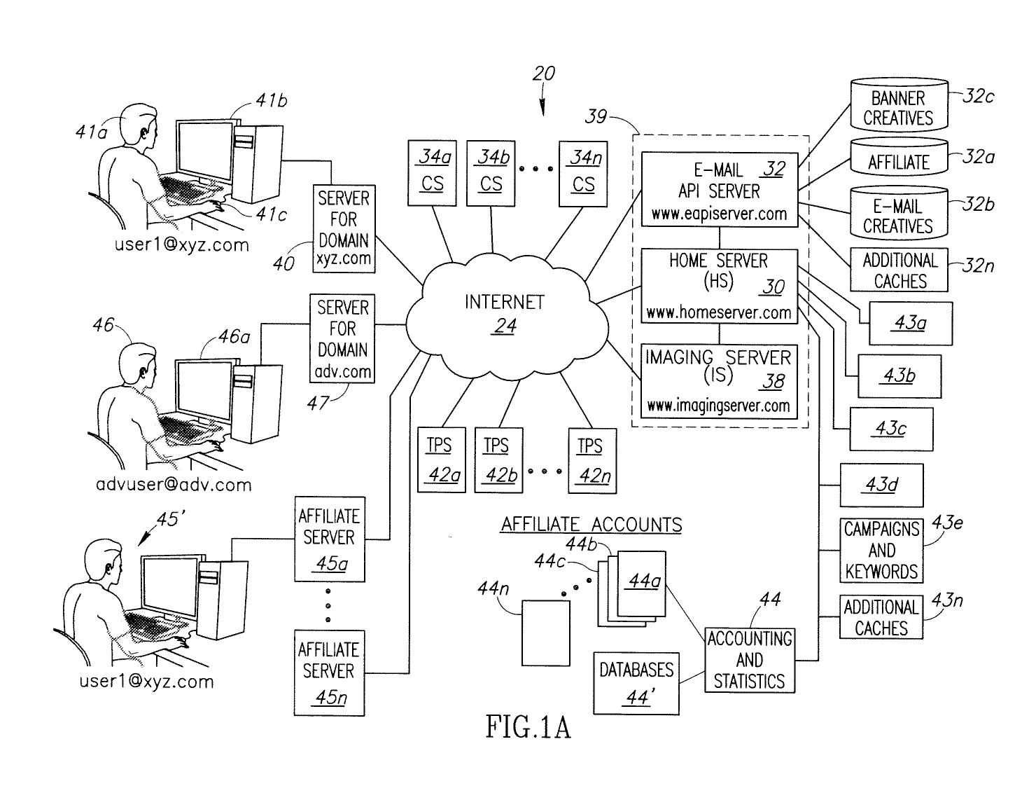

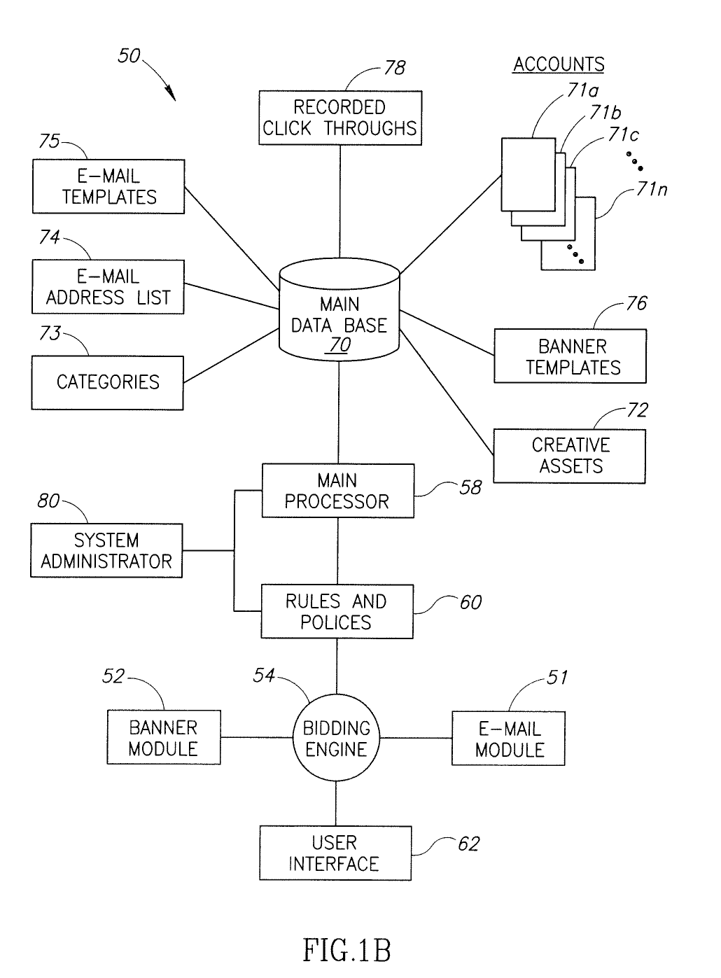

FIG. 1A shows the present disclosed subject matter in an exemplary operation. The present disclosed subject matter operates in a system 20, formed of various servers and server components, that are linked to a communications network, such as a wide area network (WAN), that may be, for example, a public network such as the Internet 24.

There are, for example, numerous servers that form the system 20. These servers, for example, include a home server (HS) 30 (also known as a main server), an application program interface (API) server 32, one or more content servers (CS) 34a-34n, and an imaging server (IS) 38. The home server (HS) 30, API server 32 and imaging server (IS) 38, may be electronically linked internally, and may be controlled by the same entity, who is a content provider, these three servers being the base components for a main system 39 or main computer system (also known as a computer system), as shown in the broken line block. This main system 39 is typically associated with a single entity of multiple related entities.

These servers 30, 32, 34a-34n and 38 are linked to the Internet 24, so as to be in electronic communication with each other. The servers 30, 32, 34a-34n and 38 include multiple components for performing the requisite functions as detailed below, and the components may be based in hardware, software, or combinations thereof. The servers 30, 32, 34a-34n and 38 may also have internal storage media and/or be associated with external storage media. Servers 30, 32 and 38 are typically coupled in their operation to provide creatives and content therefor, for example, as creatives with activatable links (the content either placed into the creative at a predetermined time or placed into the creative when the supporting electronic communication is opened (for example, when the e-mail is opened), or a portion thereof is activated.

Affiliate servers 45a-45n, for example, each representing an affiliate (although each server 45a-45n may represent multiple affiliates), are linked to the communications network, e.g., the Internet 24. The affiliates (of each affiliate server 45a-45n) may be separate and unrelated to the entity that controls the servers 30, 32, 38 of the main system 39. This entity may also be the same entity that provides the text and images with links in the “hot spots” of the creatives. The links, when the intended recipient activates them in the creative, direct the recipient (recipient's browser or browsing application) to a targeted web site.

The servers 30, 32, 34a-34n, 38 of the system 20 are linked (either directly or indirectly) to an endless number of other servers and the like, via the Internet 24. Other servers, exemplary for describing the operation of the system 20, include a domain server 40 for the domain (for example, the domain “xyz.com”) of the user 41a (for example, whose e-mail address is user1@xyz.com), linked to the computer 41b of the user 41a. Still other servers may include third party servers (TPS) 42a-42n, controlled by advertisers, content providers, web site promoters, affiliates, and other entitles, that may or may not be related to any of the entities detailed above.

For example, the intended recipient or user 41a has a computer 41b (such as a multimedia personal computer with a Pentium® CPU, that employs a Windows® operating system), that uses an e-mail client. The computer 41b is linked to the Internet 24. The computer 41b may also be operated by an activatable pointer, such as a mouse 41c or the like. The user 41a may have an e-mail address, for example, of user1@xyz.com.

While various servers have been listed, this is exemplary only, as the present disclosed subject matter can be performed on an endless numbers of servers and associated components that are in some way linked to a network, such as the Internet 24. Additionally, all of the aforementioned servers include components for accommodating various server functions, in hardware, software, or combinations thereof, and typically include storage media, either therein or associated therewith. Also in this document, the aforementioned servers, storage media, and components can be linked to each other or to a network, such as the Internet 24, either directly or indirectly.

The home server (HS) 30 is of an architecture that includes one or more components, modules, engines, applications, computer devices, and the like, for providing numerous additional server functions and operations, for example, comparison and matching functions, policy and/or rules processing, various search and other operational engines, browser directing and redirecting functions, and the like. The home server (HS) 30 includes various processors, including microprocessors, for performing the server functions and operations detailed herein, and storage media, either internal or associated therewith, which are operationally coupled to the aforementioned processors, microprocessors, components, modules, engines, applications, computer devices, and the like. Storage media in, or operationally coupled to, the home server 30, and the main system 39 include caches 43a-43n. While these caches 43a-43n are shown, this is for explanation purposes, as the home server (HS) 30 and main system 39 may be associated with additional caches, databases, as well as numerous other additional storage media, both internal and external thereto. For explanation purposes, the home server (HS) 30 may have a uniform resource locator (URL) of, for example, www.homeserver.com.

The home server 30 includes components, such as those, for example, in commonly owned U.S. patent application Ser. No. 11/774,106, entitled: Method and System for Providing Electronic Communications With Dynamically Provided Content to Third Party Mail Transfer Agents (U.S. Patent Application Publication No. US 2008/0098075 A1), the disclosure of which is incorporated by reference herein. The home server 30 also includes the server system (architecture) 50, disclosed in commonly owned U.S. patent application Ser. No. 11/256,871, entitled: System for Prioritizing Advertiser Communications Over a Network (U.S. Patent Application Publication No. US 2006/0248110 A1), the disclosure of which is incorporated by reference herein. The server system (architecture) 50 and its components are shown in FIG. 1B, and their operation is detailed below and described in U.S. patent application Ser. No. 11/256,871. The server system (architecture) 50 is compatible with the home server 30, API server 32 and imaging server 38 of the main system 39, as disclosed in U.S. patent application Ser. No. 11/774,106. The server system (architecture) 50 of U.S. patent application Ser. No. 11/256,871 is one where advertisers, web site promoters and the like, bid for categories, keywords and search terms and the like, and provide text for the hot spots in the creative that cover links to their corresponding target web sites, as detailed further below.

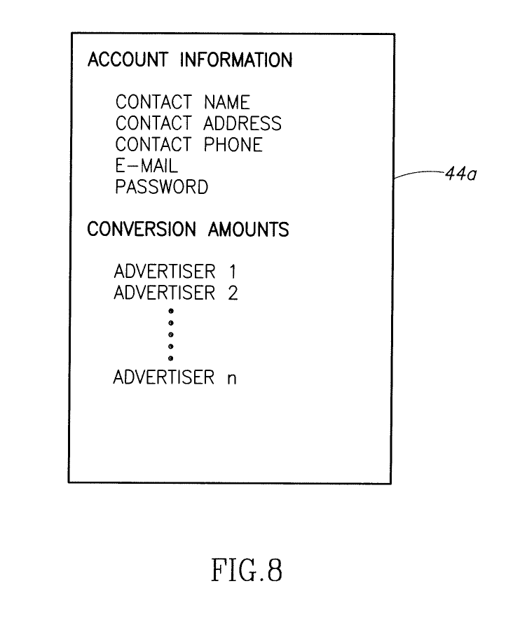

The home server 30, for example, also includes a statistics and accounting module 44, separate or part of another component, in which “conversions” are monitored, for example, for statistical and accounting purposes. The module 44 may also be used to monitor clicks, for example, also for the aforementioned purposes. The module 44 includes one or more databases, caches and the like 44′, and includes accounts 44a-44n for the affiliates, corresponding to the affiliate servers 45a-45n. The accounts 44a-44n list a conversion amount for each advertiser (e.g., FIG. 8 shows the account for an affiliate 44a, with conversion amounts for Advertiser 1 through Advertiser n, that are associated with this affiliate), or information provider with whom the corresponding affiliate (affiliate server 45a-45n) associates with, as a result of sending the electronic communication, which that results in a “conversion” (detailed below) at the advertiser's or information provider's target web site (for example, hosted by third party servers 42a-42n).

The home server (HS) 30 may employ a search engine, or link to one or more search engines (in another server or the like via the Internet 24), in order to direct the received request, data, including keywords, key word identifiers, or the like, to the most suitable content server (CS) 34a-34n. While a single home server (HS) 30 is shown, the home server (HS) 30 may be formed of multiple servers and/or other computerized components.

The API server 32 may include one or more components, modules or the like, and may be one or more servers, but is shown, for example, for description purposes as a single server. The API server 32 is of an architecture for receiving data, code, code segments (“code” and “code segments” used interchangeable herein) and the like from e-mail or other electronic communication recipients, and includes programs for automatically assigning a creative (in code, data or the like, in the cache 32b), in response to having received code segments and/or data from an affiliate requesting a creative (via transmitted code segments and/or data), to the requesting affiliate. The affiliate, via the corresponding requisite affiliate server 45a-45n, receives the data, code segments or the like, for the selected creative (to be placed into the electronic communication by the affiliate server 45a-45n), as sent by the API server 32 over the communications network, e.g., the Internet 24, to the affiliate servers 45a-45n. The API server 32 architecture also supports programs for data generation that is sent to the affiliate server 45a-45n, as well as for electronic communication with the home server (HS) 30 and imaging server (IS) 38. The API server 32, includes similar computerized components, modules and other components, to those disclosed in commonly owned U.S. patent application Ser. No. 11/774,106 (U.S. Patent Application Publication No. US 2008/0098075 A1).

The API server 32 includes various processors, including microprocessors, for performing the aforementioned server functions and operations and storage media, either internal or associated therewith, and caches. These caches are exemplary, and numerous caches are permissible. A first cache 32a is for affiliate servers 45a-45n, which received creatives (e-mails or banners) associated with the main system 39. There is a second cache 32b with HTML for the various e-mail creatives in the imaging server (IS) 38, and a third cache 32c with HTML for the various banner creatives in the imaging server (IS) 38. Other caches, databases, as well as numerous other additional storage media, both internal and external thereto, for numerous functions may also be part of the API server 32, and are designated 32n.

Content servers (CS) 34a-34n (one or more) are also linked to the Internet 24. The content servers (CS) 34a-34n provide content, for example, in text form, for the imaging server (IS) 38, typically through the home server (HS) 30 (for example, as data, code or the like from an image link returned to the home server (HS) 30, as detailed below), and, for example, in response to a request from the home server (HS) 30, as detailed below. These content servers (CS) 34a-34n may be, for example, Pay-Per-Click (PPC) servers of various content providers, such as internal providers, or external providers, for example, Overture Services, Inc. or Findwhat, Inc.

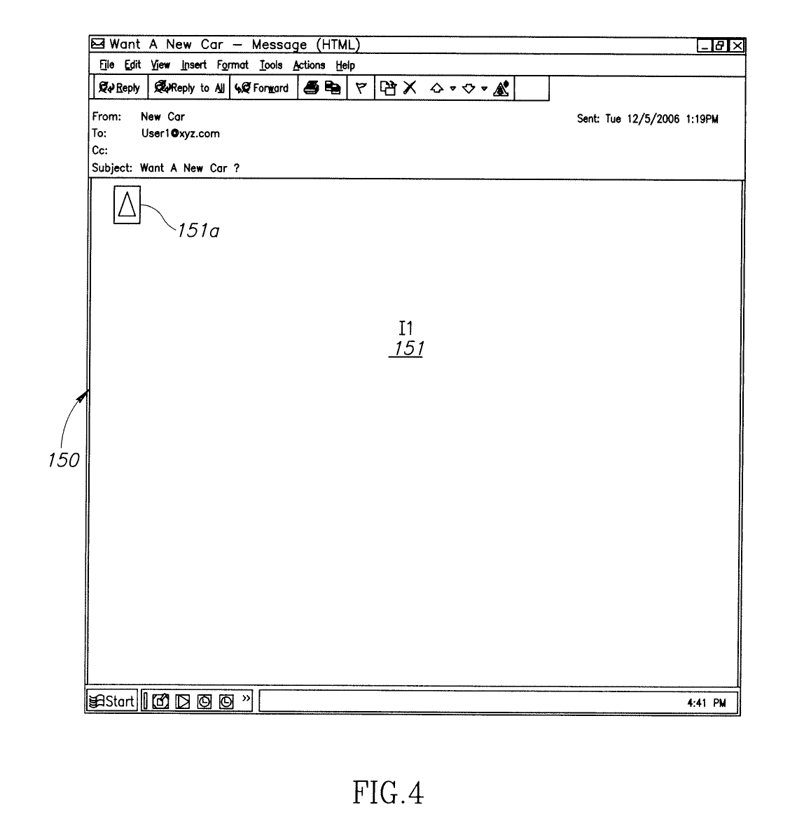

At least one imaging server (IS) 38 is linked to the Internet 24. The imaging server (IS) 38, representative of all imaging servers, functions to convert text (data in text format) from the home server (HS) 30, to an image (data in an image format). After the text is converted into an image, corresponding to the creative and the images covering the “hot spots” of the creative (collectively, “the creative”) (for example, in HTML code, from the API server 32), the image (for example, formed of multiple images to accommodate the “hot spots” as well) is typically sent back to the home server (HS) 30, that sends the image to fill the template 150 (FIG. 4), once the electronic communication, for example, an e-mail, is opened by user 41a, as detailed below.

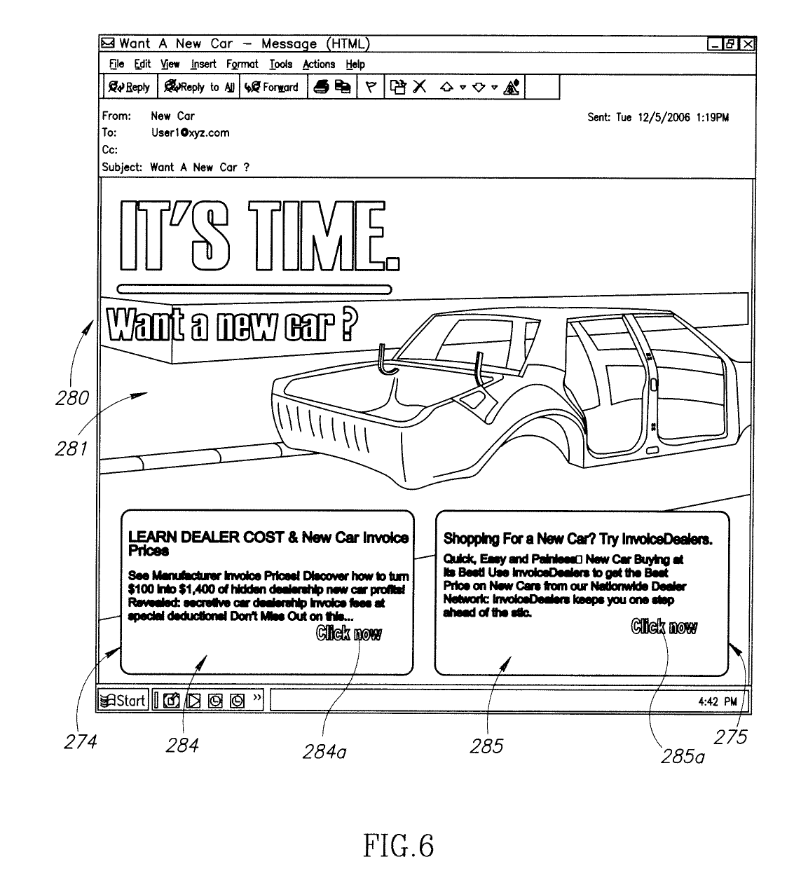

The imaging server (IS) 38 stores the requisite images corresponding to the data or code in the cache 32b (for example, placed into the requisite image links as detailed below) including all code, data and the like for all of the images associated with the creative, such as the main image for the body of the creative, which includes the hot spots 274, 275 (FIG. 6) and sub images 284, 285 (FIG. 6) that cover or fill the hot spots (as detailed below). The storage of the requisite images is by the server 38 itself, or storage devices or other servers linked to the imaging server (IS) 38. For explanation purposes, all devices and servers associated with the storage of data to produce the requisite images in the electronic communications detailed herein are represented by the imaging server (IS) 38.

Each affiliate server 45a-45n may be one or more servers, computerized components, computer devices, or the like, but is shown for description purposes as a single server. The affiliate servers 45a-45n are each of an architecture that includes databases, that store e-mail addresses of users or recipients as well as algorithms for requesting various categories, handling code and data received from the main system 39, and placing the received code or data into electronic communications and distributing the electronic communications to recipients, such as in e-mail, banners and the like, and placing data or code into the e-mail allowing it to be mapped back to the affiliate server 45a-45n.

There is also software, hardware, and combinations thereof for receiving the code of a creative from the API server 32, along with additional data, coordinating it with an e-mail address from a list, maintained by the affiliate server 45a-45n, and adding a header and footer to this acquired data, to create an electronic communication, for example, in the form of an e-mail. The e-mail is sent from the affiliate server 45a-45n to the intended recipient, for example, user 41a at the e-mail address user1@xyz.com, typically directly, over the communications network, for example, the Internet 24.

Additionally, an affiliate user 45′, via a web-based interface, links to the main system 39 (and its component servers 30, 32, 38), through its corresponding affiliate server, for example, affiliate server 45a. This allows the affiliate user 45′ to manually or automatically select the creative(s) desired, for the processes detailed below, and send requests, manually or automatically, for these selected creatives to the API server 32 of the main system 39. The web-based interface, for example, facilitates viewing of preview images and the like for the creative and the campaigns, categories, keywords, search terms, and the like associated with each creative. This allows for the affiliate user 45′ to select the desired creative(s) and associated campaigns, categories, keywords, search terms, or vice versa, and manually or automatically request these selected creatives from the main system 39.

FIG. 1B shows an alternate or augmented configuration for the home server 30, or main server. Home server 30 includes a server system (architecture) 50, which includes components for performing the methods and processes of the present invention. It also includes components and arrangements thereof, for supporting e-mail functionalities and banner functionalities, which overlay the displayed web pages, and other graphic functionalities.

The e-mail functionalities are typically performed by an e-mail module 51. These functionalities include handling (generating, sending receiving, collating, etc.) electronic mail, and performing other e-mail applications. The home server (HS) 30 also includes components for recording events, such as when e-mails are sent, whether or not there has been a response to an e-mail (a certain time after the e-mail has been sent), whether the e-mail has been opened, and whether the opened e-mail has been “clicked”, such that the browser of the user is ultimately directed to target web site, corresponding to the link that was “clicked”. When the user's browser reaches the target web site, this event is considered to be a “click through.”

The e-mails, sent by the affiliate server 45a-45n or the home server (HS) 30, are typically e-mails where text and graphics are preset for a template, and the URL placed therein is set to a specific targeted web site. These e-mails are assembled by conventional techniques and sent by conventional methods. The e-mails may also include attributes of the e-mails, as disclosed in commonly owned U.S. patent application Ser. No. 10/915,975.

The banner functionalities are performed by a banner module 52. These functionalities include handling (generating, sending receiving, collating, etc.) banners, and performing other associated applications. The server system (architecture) 50 also includes components, for example, the sub-database 78 for recording events, such as whether or not there has been a click through in response to the banner having been sent.

The banners sent by the affiliate servers 45a-45n or the home server (HS) 30, may be banners in accordance with conventional banner producing software, hardware or combinations thereof used in servers and the like.

The home server (HS) 30 also performs accounting functions such as debiting accounts of advertising users upon valid click throughs (detailed below), as well as crediting accounts with funds when entered into the server system (architecture) 50. For example, funds may come into the server system (architecture) 50 from credit cards, bank transfers and the like. For example, accounts may be debited and/or credited manually, by the system administrator or the like, or automatically.

The server system (architecture) 50 includes components for providing numerous additional server functions and operations. In particular, there is a bidding engine 54, which performs functions for advertiser and information provider bid administration and other functions associated with these bids. There are also processors 58, including microprocessors, for performing for performing the aforementioned server functions and operations.

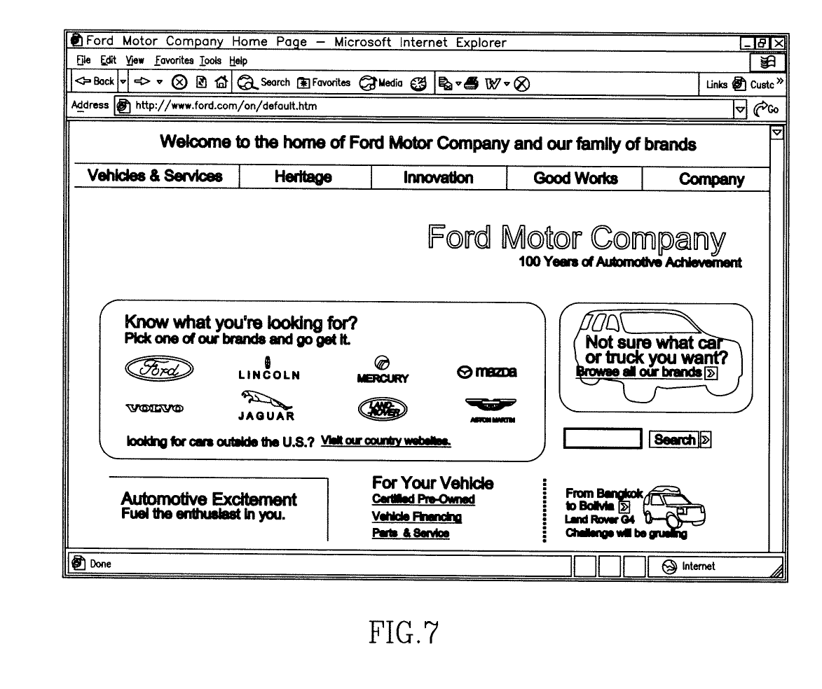

The server system (architecture) 50 also includes components, for example, comparison and matching functions, policy and/or rules processing, various search and other operational engines. There is also a rules and/or rules and policies processor 60 associated with the bidding engine 54 for determining the categories from which the sent e-mail or banner will correspond. A user interface 62, allowing users to interact with the server system (architecture) 50, this user interface 62 is typically coupled to the bidding engine 54. The user interface 62, for example, a graphical user interface (GUI), for example, as used by advertising users (represented by the advertising user 46 whose e-mail address is adviser@adv.com, whose computer 46a is linked to the internet via a domain server 47 for the domain adv.com, as shown in FIG. 1A) functions to receive data from and input into the server system (architecture) 50. For example, the advertising user 46 may be the advertiser whose web page or web site is hosted by a third party web server 42a-42n, such as the Ford Motor Company, whose associated third party server 42a-42n has the URL www.ford.com, and whose target web site hosted thereon is shown in FIG. 7, as detailed below.

The server system (architecture) 50 also includes a database or data store 70, with multiple sub-databases or sub-data stores. Exemplary sub-databases include information for each account 71a-71n, an in particular, files for account information (contact name, contact address, contact phone number, e-mail of responsible party, password, e-mail preferences, campaign name, acceptance of terms with name and initials of accepting party, the creative or creatives assigned to each selected category, the creative assets including text and URL associated with each creative asset assigned to each selected category, the selected category or categories, the channels selected, web and e-mail, an amount to be paid for a click through over the web channel, an amount to be paid for a click through over the e-mail channel, a daily campaign budget, and a campaign budget). Other sub-databases, for example, include those for creative assets 72 (unfilled or modifiable creatives-creatives with spaces for receiving the text, including the URL for a targeted web site, that is entered by the advertising user 46), categories 73, e-mail address list 74, e-mail templates 75, banner templates 76, and, recorded click throughs 78.

The server system (architecture) 50 is also such that the main processor 58 and rules and policies 60 can be programmed from a module 80. This module 80 may be internal or external to the server system (architecture) 50, and electronically linked to the main processor 58 and the rules and policies 60. The module 80 is typically operated by a system administrator, or the like. Additional functions of the server system (architecture) 50 are disclosed in U.S. patent application Ser. No. 11/256,871, the disclosure of which is incorporated by reference herein.

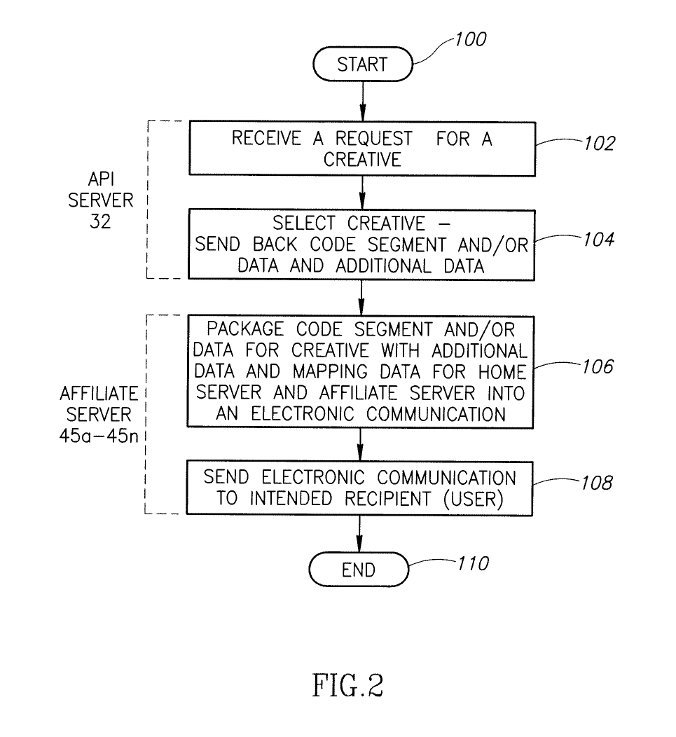

Turning also to FIG. 2, an exemplary implementation of a process in accordance with an embodiment of the disclosed subject matter is now described. FIG. 2 is flow diagram of the process (method), for selecting the contents of the communication that the affiliate server 45a will send to the intended recipient (user), for example, user 41a.

The process of FIG. 2 may be the first phase of a larger process. For example, the first phase may involve selecting a creative to be placed into an e-mail. In another phase, the e-mail is rendered to an e-mail client, by the respective affiliate server 45a-45n and detailed below. In another phase, the browsing application of the e-mail recipient or user is directed to a target web site, via a link, that is activated once the user 41a has clicked his mouse 41b on a portion of the image covering the dynamically rendered link, of the creative, that appeared on the screen display of the user 41a when the e-mail was opened. All three of these phases are typically performed in real time.

Initially, the computer 41b of the user 41a includes an e-mail client (detailed above), installed thereon, that provides the user with a unique address and the ability to utilize one or more e-mail addresses. For example, the user 41a has an e-mail address, user1@xyz.com, through which he receives his e-mail from the domain server 40 that hosts the domain xyz.com, of which the user 41a is a member. The computer 41b also includes a web browser, browsing software, application, or the like, to access web sites or web pages from various servers and the like, on the Internet 24. Some exemplary web browsers/web browsing software includes, Internet Explorer®, from Microsoft, Redmond, Wash., and Netscape® Navigator®.

Prior to or contemporaneous with the START (block 100), typically within the affiliate server 45a (affiliate server 45a is exemplary of all affiliate servers 45a-45n), requests are made for creatives for various categories. This can also be performed, for example, manually by the affiliate user 45′, through a web-based interface, selecting the creatives from the requisite caches, for example, 32b, 32c of the main system 39 (or from the creative assets 72 of the server system (architecture) 50) and making manual requests for creatives, as detailed above.

This data (as a request) from the affiliate server 45a or the affiliate user 45′ is now received in the API server 32, at block 102. The data encodes for a category, keyword, search term or the like. The API server 32 interprets the data of the request and automatically selects a creative (in a code segment and/or data), for an equivalent or similar campaign or category to satisfy the request, and sends it back in a code segment and/or data at block 104. This receiving the request and sending the code segment and/or data back to the affiliate server 45a is performed, for example, automatically, by the API server 32.

The sent back code segment and/or data also includes requests, including content requests, for the creative, typically corresponding to the number of content requests and positions for dynamically generated content in the creative. The API server 32 automatically returns the code or data for the creative to the affiliate server 45a, at block 104. The affiliate server 45a then packages the code segment and/or data for the creative, including the requests in an electronic communication, for example, an e-mail or banner, along with code segments and/or data that maps to the home server 30, when the electronic communication is opened. The code segments and/or data for the creative include embedded data read by the servers or components, for example, the home server (HS) 30, that provide the images for the creative (main image and images for the hot spots of the main image, via the imaging server (IS) 38), activatable links for the hot spots, and data for redirecting the browser or browsing application of the intended recipient (user) of the electronic communication to a URL corresponding to the activatable link of the requisite hot spot, once the activatable link has been activated or clicked.

Also packaged into the electronic communication are code segments and/or data for mapping the communication recipient's clicks back to the affiliate server 45a, for example, for tracking and accounting purposes, an extracting the numerical address of the computer associated with the recipient (user), and providing it to the home server 30.

Alternately, the home server 30 includes a request cache (not shown) affiliated with each creative. The request cache stores requests, that include content requests, associated with each creative. By virtue of the electronic communication, including each of the hot spots in the creative mapping to the home server 30, and accordingly, the request cache, the request corresponding to the hot spot of the creative is automatically activated at the time the hot spot in the creative is activated by a mouse click or other activation, as detailed further below.

The affiliate server(s) 45a-45n, the home server 30, and API server 32 are programmed to accommodate numerous requests for creatives and the sending of code segments and data for the selected creatives contemporaneously.

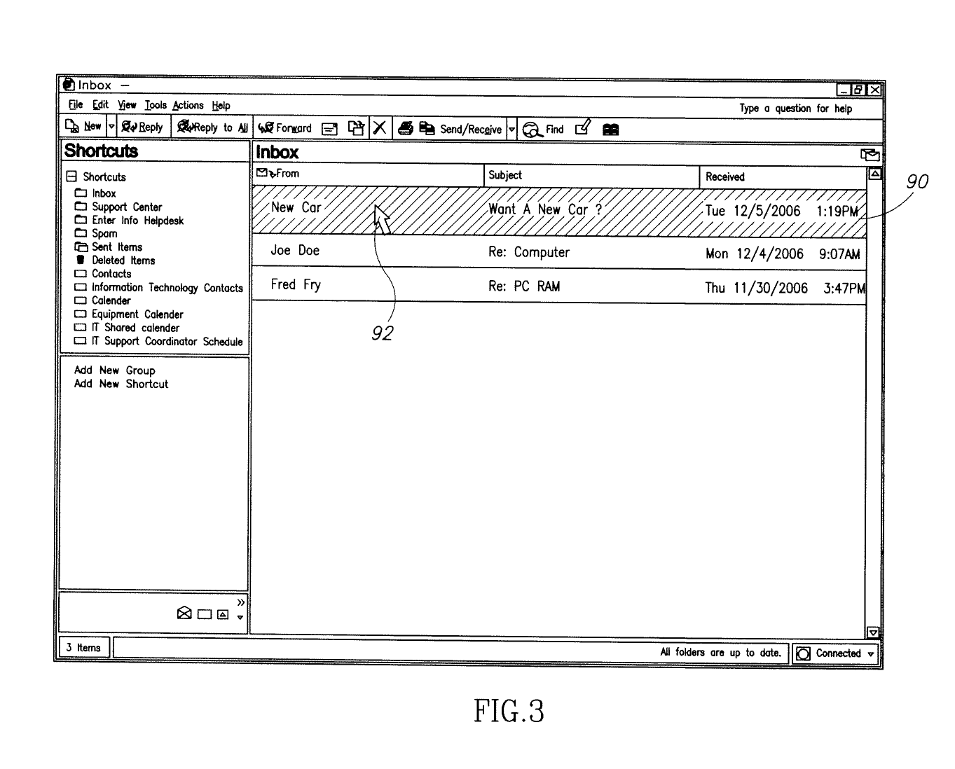

The now created electronic communication, is now sent to a recipient selected by the affiliate server 45a, at block 106. The affiliate server 45a originates and initiates the electronic communication, and recipients are typically from a list, for example, e-mail recipients, or in the case of banners, for example, publishers, web sites and the like. The electronic communication, for example, an e-mail, is sent to the e-mail client associated with the intended recipient (user), at block 108, and appears as a text line 90, in the recipient's (user's) IN box, as shown in FIG. 3. The process for this electronic communication ends at block 110, but the process can be repeated for as many electronic communications as are needed, multiple processes can occur contemporaneously.

The recipient (user) then opens the received e-mail by an activation such as a mouse click 92 (FIG. 3), anywhere along the text line 90. The mouse click opens the e-mail and automatically causes the opening of a connection or “pipe” over the network, e.g., the Internet 24. The connection or “pipe” is between the recipient's (user's) computer 41b (the e-mail having been sent by the affiliate server 45a to user1@xyz.com, corresponding to the recipient (user) 41a), the corresponding e-mail client and the home server 30.

The code segments and/or data packaged into the e-mail by the affiliate server 45a, are sent back automatically to the home server 30, upon this opening of the electronic communication, e.g., e-mail, as the code segments and/or data is mapped to the home server 30. The home server 30 sends back a template 150 (FIG. 4), that forms the basic structure or framework for the image(s) of the opened e-mail, and, zero or more HTTP Source requests for zero or more static images. The sent e-mail may also include HTML constructs and text, such as plain text, HTML headers, list constructs and the like.

With the request received in the home server (HS) 30, the creative, the code for which is embedded in the request data (that includes the locations for the hot spots) is pulled from the imaging server (IS) 38, where its image data is stored, and is sent back to the home server 30. The data for the image is sent onward to the e-mail client for placement into the template 150 in the image location 11151 in replacement of the box 151a, as shown in FIG. 4.

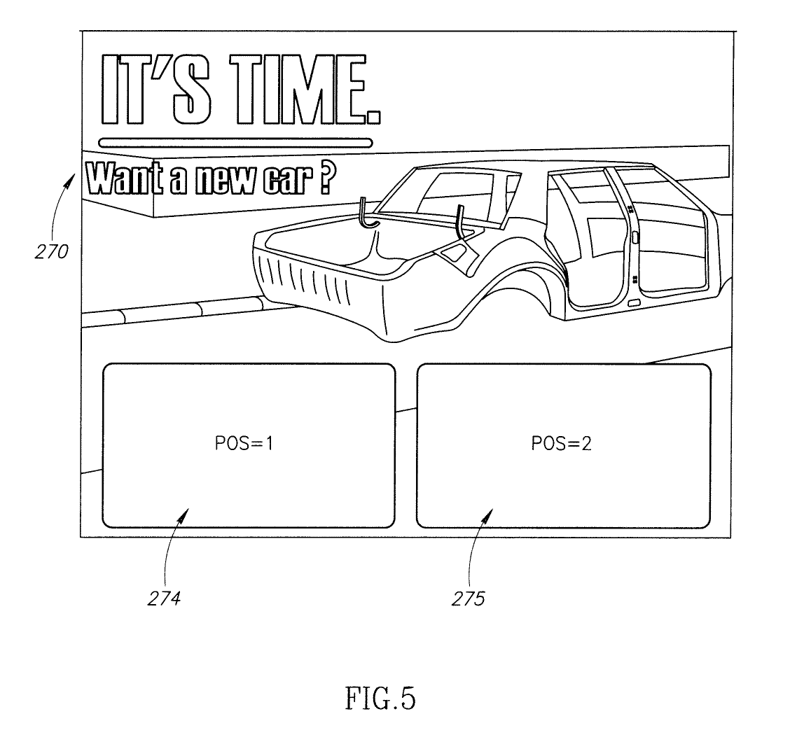

The home server 30 automatically renders the creative to the template 150 as an image (represented by the box 151a), at the single position (I1) 151, and is now an opened e-mail (as detailed above). As shown in FIG. 5, the creative 270 includes two positions or hot spots 274, 275, the positions indicated by POS=1 and POS=2. The opened e-mail 280, includes the rendered image for the creative 281, the creative 281 also known as the main image or body. The creative 281 (main image or body), is typically a static image and may include “hard” HTML links, and includes locations for the hot spots 274, 275, with images or sub images 284, 285 filling the hot spots 274, 275. The creative 281 appears on the monitor of the computer 41b of the user 41a, as a viewable image, for example, as the screen shot of FIG. 6. The hot spots 274, 275 support dynamically generated content, generated as detailed below. The hot spots 274, 275 include activatable locations 284a, 285a over underlying links, which are activatable and linked to destination web pages or web sites. When these activatable locations 284a, 285a are activated or “clicked on,” this action ultimately causes the browsing application associated with the recipient's (user's) computer 41b to be redirected to a target web site corresponding to the link underlying the activated or clicked on hot spot 274, 275. For example, the creative obtained and displayed in FIG. 6 may be that as disclosed in U.S. patent application Ser. No. 11/774,106.

The requests, are received by the home server 30, are then processed automatically. The requests are analyzed and the category or campaign of the request is linked or otherwise associated with a category, campaign, keyword, search term or the like (in the cache 43e), so as to obtain listings from content servers 34a-34n, in a manner similar to that described in U.S. patent application Ser. Nos. 10/915,975 and 11/774,106. There is for example, one request for each hot spot 284, 285 of the e-mail 280.

The images (sub images) 284, 285 (in e-mail 280), are typically selected and placed into the hot spots 274, 275 when the e-mail 280 is opened and in accordance with the listings selected to be the links (in accordance with the processes detailed herein). These images 284, 285, include portions 284a, 285a (activatable locations), that cover links for the user to click on, and are indicated as such, for example, “Click now.” (The portions or activatable locations 284a and 285a, which include and cover the links, are interchangeable with the links and reference numerals 284a and 285a). These underlying links 284a, 285a, when activated, typically by a mouse click, ultimately provide the browser of the user 41a with a redirect URL, directing the browser to a target web site (or web page). This web site (or web page) is from the listing that resulted in the image that supported the clicked or activated link.

The obtained listings correspond to the links underlying the hot spots 274, 275. The listings include redirect URL's associated with target web sites, with one listing for each of the respective links of the hot spots 274, 275. The URL's for each listing and each respective link for each hot spot 274, 275 may be stored in caches in the home server 30, as detailed in U.S. patent application Ser. Nos. 10/915,975 and 11/774,106, with the caches mapped to each respective hot spot 274, 275 and the link associated therewith. Alternately, the URLs from each listing may be placed directly into the link for the respective hot spot 274, 275, with each link mapped back to the home server 30 for accounting, administrative, statistical purposes and the like.

Once the activatable location 284a, 285a of the hot spot 274, 275 is activated or clicked on (the “pipe” may be open or reopened), the recipient's (user's) browsing application is redirected to the target web site, via the home server 30 (transparently), similar to that disclosed in as disclosed U.S. patent application Ser. Nos. 10/915,975 and 11/774,106 (with an error message provided if appropriate as disclosed in U.S. patent application Ser. Nos. 10/915,975 and 11/774,106). This process is performed automatically. The aforementioned browsing application redirect may also be directed to the target web site, with the activation or click mapped back to the home server 30. The home page of the target web site is shown, for example, in FIG. 7, where the URL for the obtained listing for the link of the hot spot activated or clicked on is www.ford.com. The home server 30 records this redirect or activation therefore, for accounting, administrative, statistical purposes and the like, in the database 44′.

Alternately, the request(s) can remain in the request cache (not shown, as indicated above). The hot spots 274, 275, via their underlying links, are mapped to the respective request in the request cache. When the link of the respective hot spot 274, 275 is activated (the “pipe” may be open or reopened), the request corresponding to the activated hot spot and corresponding link is analyzed, and the category or campaign is linked or otherwise associated with a keyword (in the cache 43e), search term or the like, so as to obtain a listings from content servers 34a-34n, in a manner similar to that disclosed in U.S. patent application Ser. Nos. 10/915,975 and 11/774,106.

Once the listing is obtained, the URL of the listing is extracted and used to redirect the browser associated with the recipient's (user's) computer 41b to the target web site, for example, hosted by one of the third party servers (TPS) 42a-42n. This is performed automatically. The home page of the target web site is shown, for example, in FIG. 7, where the URL for the obtained listing for the link of the hot spot activated or clicked on is www.ford.com. The home server 30, via module 44, records this redirect for accounting, administrative, statistical purposes, accounting for conversions (as detailed below) and the like, in the database 44′.

Alternately, should content for the hot spots 274, 275 be provided by the home server 30 employing the server system (architecture) 50, as disclosed in U.S. patent application Ser. No. 11/256,871, the requests, if sent back with the code segment and/or data are processed such that the hot spots are provided with links that include URL's for target web sites corresponding to advertisers in the system, who have placed bids for categories, keywords, search terms or the like. Each request is matched with requisite category to obtain the listing and its associated URL for the hot spot. For example, if the creative is the creative 280, it has two hot spots 274, 275. The image and link for the highest bidding advertiser or information provider for the category, keyword or search term is placed be in the left hot spot 274, or Position 1 (POS=1), while the second highest biding advertiser or information provider would have its image and link in the right hot spot 275, or Position 2 (POS=2), with both hot spots 274, 275, via their links, mapped to the home server 30 (from where the browser of the user is redirected to the target web site for the requisite advertiser or information provider).

Once the activatable location 284a, 285a of the respective hot spot 274, 275 is activated or clicked on (the “pipe” may be open or reopened, as detailed for the “pipe” above), the recipient's (user's) browsing application is redirected (automatically) to the target web site, as detailed immediately above. The activation or click is mapped back to the home server 30, which records this redirect or activation therefore, for accounting, administrative, statistical purposes, accounting for conversions (as detailed below) and the like, in the database 44′.

Alternately, for the home server 30 employing the server system (architecture) 50, as disclosed in U.S. patent application Ser. No. 11/256,871, the hot spots 284, 285, include underlying links, which are dynamic. Embedded in these links is data and/or code segments with the category and/or campaign, from which the content (e.g., the listing for the advertiser with the URL to the advertiser's target web site) is selected, as well as data and/or code segments mapping to the home server 30. When the link of the respective hot spot 274, 275 is activated (the “pipe” may be open or reopened), the home server 30 analyzes the data and/or code segment, and the category or campaign is connected or otherwise associated with an advertiser's listing, including the advertiser's URL, in accordance with their bid for the category, keyword, search term or the like. The URL of the listing is extracted and used to redirect the browser associated with the recipient's (user's) computer 41b to the target web site, corresponding to the extracted URL. The home server 30 records this redirect, click or activation, for accounting, administrative, statistical purposes, accounting for conversions (as detailed below) and the like.

For the home server 30 employing an architecture as disclosed in U.S. patent application Ser. No. 11/256,871, the clicks are mapped back to the home server 30 for monitoring, allowing for their evaluation. The clicks may be used in accounting for payments from advertiser accounts in pay-per-click modes, where an advertiser's account is debited by a bid amount (to be paid to the entities who provided the URL, via the activatable link, to the recipient or user), each time a link with that advertiser's URL is clicked on or otherwise activated (to cause a browser redirect to the advertiser's target web site).

Alternately, the clicks or activations can be monitored for conversions. These conversions can be used as the revenue measure, to avoid click fraud, as such fraud is becoming more commonplace with pay-per-click applications. Conversions are events that occur at an advertiser's target web site, for example, one of the third party websites 42a-42n, which are monitored by the advertiser. A conversion is defined by the advertiser, but is, for example, a consumer purchase of a good or service from the advertiser web site, a consumers providing information to the web site, or a consumer requesting information from the web site, or any other advertiser-defined event. Conversions are reported from the advertiser to the home server 30. The home server 30, via the module 44, connects the advertiser associated with the conversion to the affiliate, who sent the electronic communication resulting in the conversion, by virtue of the initially sent electronic communication being mapped to the affiliate server 45a-45n, which sent the e-mail, and the home server 30, as detailed above. The module 44 debits the advertiser's account by a conversion amount, as listed for the affiliate's account for that advertiser (for example, as shown by the account 44a of FIG. 8, with the advertiser from whom the conversion was made being advertiser A), and credits the affiliate's account by this conversion amount.

The conversion amount is typically greater than a pay per click amount, as not all clicks or other activations of a link to reach a target web site, result in a conversion at the target web site. However, single clicks can be fraudulent, as these clicks are made by machines, entities, or individuals, who do not have any intent to browse (or interact with) the target web site. If such fraudulent clicks are not detected promptly, an advertiser's account can be depleted rapidly, without legitimate recipients (users) ever having reached the advertiser's target web site.

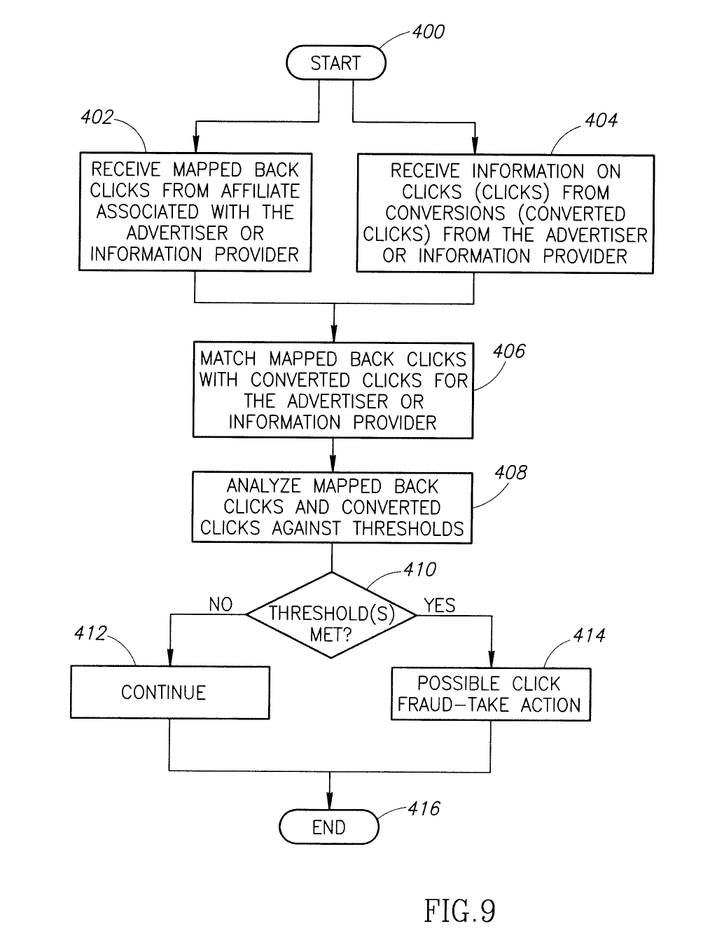

FIG. 9 details a process for detecting fraudulent clicks. The process begins at block 400. Clicks are received in the home server 30 from the advertiser, i.e., clicks for conversions, at block 402, and from the affiliate server 45a-45n, that were directed to the advertiser, and are mapped back to the requisite affiliate server, at block 404.

The home server 30 then matches the converted click (sent from the advertiser or information provider, as recoded for example, on the third party server 42a-42n associated with the advertiser or information provider) with the corresponding mapped back click from the affiliate (affiliate server 45a-45n) who provided the electronic communication that resulted in the click (via the initially sent e-mail being mapped to both the affiliate server 45a-45n, that sent the e-mail, and the home server 30), at block 406. This matching is also performed to determine and analyze conversion rates. The home server 30, through the accounting and statistics module 44, may additionally analyze the quality of the clicks from each affiliate (affiliate server 45a-45n), to determine the conversion amount to be received by the affiliate.

For example, the converted clicks (from the advertiser, for example, as received at the advertiser's associated third part server 42a-42n) may be compared against the mapped back clicks (from the affiliate server 45a-45n associated with the particular advertiser) on a time and/or number basis, based on a threshold, for example, a certain number of mapped back clicks and conversion clicks over a predetermined time period (the mapped back clicks over the predetermined time period defining a threshold(s)), or only a certain number of mapped back clicks (a threshold) and conversion clicks, at block 408. It is determined at block 410 is the system selected threshold is met.

If the threshold is not met, operation of the systems continues, without substantial changes, at block 412. For example, the advertiser's account is debited by the click amount and/or conversion amount. If the threshold is met or exceeded, this is a possible click fraud situation, and the system takes action, at block 414. For example, the action taken may be that the advertiser's or information provider's account in the home server 30 would not be debited by the bid (PPC) or other amount. Additionally, for example, the home server 30/main system 39 would block a user or other entity's internet protocol (IP) address. This process may then be repeated, or ended at block 416. For example, if 40 non converted mapped back clicks from the same affiliate server 45a-45n/home server 30 within a two hour period without a conversion, the home server 30/main system 39 would block the user or clicking entity from reaching (via their browsing application) the home server 30 and accordingly, the third party server 42a-42n of the requisite advertiser or information provider. Accordingly, the advertiser's or information provider's account in the home server 30 would not be debited by the bid or other amount. Additionally, for example, the home server 30/main system 39 would block a user or other entity's internet protocol (IP) address if the most recent 500 conversion tracked clicks, i.e., the mapped back clicks, have not resulted in a conversion during the time period of the 500 clicks.

This process may then be repeated, by returning to the START of block 400, or ended at block 416.

While e-mail electronic communications have been shown and described above, the electronic communications including banners, from banner creatives cache 32c (FIG. 1A) and Banner Templates 76 and Banner Module 52 of the server system (architecture) 50 (FIG. 1B) would operate similarly in the requisite systems, to the e-mail processes detailed above. The recipients would be publishers, web sites, etc., as detailed for the e-mail processes and systems above.

The above-described processes (methods) including portions thereof can be performed by software, hardware and combinations thereof. These processes and portions thereof can be performed by computers, computer-type devices, workstations, processors, microprocessors, other electronic searching tools and memory and other storage-type devices associated therewith. The processes and portions thereof can also be embodied in programmable storage devices, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

While preferred embodiments of the disclosed subject matter disclosed subject matter have been described, so as to enable one of skill in the art to practice the present disclosed subject matter, the preceding description is intended to be exemplary only. It should not be used to limit the scope of the disclosed subject matter, which should be determined by reference to the following claims.

What is claimed is:

1. A computer-implemented method for providing content into electronic communications over a communications network comprising:
a computer system, linked to the communications network, the computer system receiving a request for a body for an electronic communication over the communications network from an affiliate user of the computer system, the body for the electronic communication selected by the affiliate user accessing the computer system to select the body;
the computer system sending data corresponding to the selected body to a computer device associated with the affiliate user, over the communications network, the computer device linked to the communications network, the data corresponding to the selected body for placement into electronic communications of the affiliate user, the electronic communications for transmission to computers of intended recipients over the communications network, the computers of the intended recipients linked to the communications network, the intended recipients as designated by the affiliate user;
the computer system receiving the data corresponding to the selected body from an electronic communication opened on a computer of an intended recipient, the data additionally including at least one content request, the opening of the electronic communication automatically transmitting the data of the at least one content request to the computer system; and,
the computer system responding to the received data by automatically providing to the computer of the recipient, to the opened electronic communication: 1) data for an image for the body, and, 2) content for at least one portion of the body, the content corresponding to the at least one content request.

2. The method of claim 1, wherein the computer system automatically providing: 1) data for an image for the body, and, 2) content for at least one portion of the body, includes, the computer system, sending to the opened electronic communication of the computer of the recipient of the electronic communication: 1) the data for an image for the body of the opened electronic communication for display on the recipient computer, to the recipient computer, and, 2) the content for at least one portion of the body of the opened electronic communication, to the recipient computer, the content associated with a target web site.

3. The method of claim 2, wherein the image for the body includes a creative, and the at least one portion of the body includes a hot spot in the creative, the hot spot configured for being activated and for supporting at least one activatable link associated with the content, the hot spot, when activated, causing activation of the at least one activatable link, such that the browsing application, associated with the computer of the recipient, is directed to the target web site.

4. The method of claim 1, wherein the electronic communication includes electronic mail (e-mail).

5. The method of claim 1, wherein the electronic communication includes at least one banner.

6. A system for providing content into electronic communications over a communications network comprising:
a computer system linked to the communications network, the computer system configured for:
receiving a request for a body for an electronic communication over the communications network from an affiliate user of the computer system, the body for the electronic communication selected by the affiliate user accessing the computer system to select the body;
sending data corresponding to the selected body to a computer device associated with the affiliate user, over the communications network, the computer device linked to the communications network, the data corresponding to the selected body for placement into electronic communications of the affiliate user, the electronic communications for transmission to computers of intended recipients over the communications network, the computers of the intended recipients linked to the communications network, the intended recipients as designated by the affiliate user;
receiving the data corresponding to the selected body from an electronic communication opened on a computer of an intended recipient, the data additionally including at least one content request, the opening of the electronic communication automatically transmitting the data of the at least one content request to the computer system; and,
responding to the received data by automatically providing to the computer of the recipient, to the opened electronic communication: 1) data for an image for the body, and, 2) content for at least one portion of the body, the content corresponding to the at least one content request; and
at least one storage media in communication with the computer system for storing data for bodies for electronic communications.

7. The system of claim 6, wherein the computer system includes an imaging server for converting text data into data for images for the bodies of opened electronic communications.

8. A computer-implemented method for detecting fraudulent clicks over a communications network, comprising:
receiving, by a computer system linked to the communications network, 1) clicks from electronic communications for a target data object, from an affiliate server mapped back to the computer system, and, 2) data for clicks resulting in conversions for the target data object associated with the electronic communications from the affiliate server;
analyzing, by the computer system, the mapped back clicks and the data for the clicks resulting in conversions with respect to at least one threshold; and
determining possible fraudulent clicks, by the computer system, if the mapped back clicks at least meet or exceed the at least one threshold.

9. The method of claim 8, additionally comprising: matching, by the computer system, the mapped back clicks with the corresponding data for the clicks resulting in conversions, for the entity associated with the target data object.

10. The method of claim 9, additionally comprising, maintaining, by the computer system monetary accounts for entities associated with target data objects, the entities also associated with affiliates and their corresponding affiliate servers.

11. The method of claim 10, wherein if the at least one threshold is either met or exceeded, the computer system ceases to debit the account of the entity associated with the target data object by an amount for each mapped back click.

12. The method of claim 11, wherein the amount for each mapped back click includes a bid amount for a click made by the entity associated with the target data object.

13. The method of claim 10, wherein if the at least one threshold is either met or exceeded, the computer system blocks the internet protocol (IP) address of the target data object.

14. The method of claim 8, wherein the at least one threshold is based on at least one of, 1) a predetermined number of mapped back clicks for the target data object over a predetermined time, or 2) a predetermined number of mapped back clicks for the target data object as mapped back through the affiliate server.

15. The method of claim 8, wherein the target data object includes at least one of a web page or a web site.

16. A system for detecting fraudulent clicks over a communications network, comprising:
at least one server for linking to a communications network comprising:
a storage medium for storing computer components; and
a processor for executing the computer components comprising:
a first component for receiving, 1) clicks from electronic communications for a target data object from an affiliate server, the clicks mapped back to the computer system from the affiliate server, and, 2) data for clicks resulting in conversions for the target data object associated with the electronic communications from the affiliate server;
a second component for analyzing the mapped back clicks and the data for the clicks resulting in conversions with respect to at least one threshold; and
a third component for determining possible fraudulent clicks, if the mapped back clicks at least meet or exceed the at least one threshold.

17. The system of claim 16, additionally comprising: a fourth component for at least one of, 1) ceasing to debit the account of the an entity associated with the target data object by an amount for each mapped back click, or 2) blocking the internet protocol (IP) address of the target data object; if the at least one threshold is either met or exceeded.

18. The system of claim 16, wherein the at least one server includes a plurality of servers.

19. The system of claim 16, wherein the at least one server includes one server.
